(19) United States
(12) Patent Application Publication
(10) Pub. No.: US 2009/0240670 A1
(43) Pub. Date: Sep. 24, 2009

(54) UNIFORM RESOURCE IDENTIFIER ALIGNMENT

(75) Inventors: Mahesh Tiyyagura, Andhra Pradesh (IN); Krishna Leela Poola, Bangalore (IN)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/051,956

(22) Filed: Mar. 20, 2008

(51) Int. Cl. G06F 7/06; G06F 17/30

(52) U.S. Cl. 707/4; 707/104.1; 707/E17.108

(57) ABSTRACT

Subject matter disclosed herein may relate to alignment of uniform resource identifiers associated with web pages, and further may relate to multiple sequence alignment of uniform resource identifiers. In one or more example embodiments, multiple sequence alignment techniques may provide improved tokenization of uniform resource identifiers associated with web pages, which may provide improved performance of applications such as, for example, uniform resource identifier normalization, sitemap construction, etc.

### FIELD

Subject matter disclosed herein may relate to the alignment of uniform resource identifiers associated with web pages.

### BACKGROUND

The Internet is a worldwide system of computer networks and is a public, self-sustaining facility that is accessible to tens of millions of people worldwide. The most widely used part of the Internet is the World Wide Web, often abbreviated “WWW” or simply referred to as just “the web”. The web is an Internet service that organizes information through the use of hypermedia. The HyperText Markup Language (“HTML”) is typically used to specify the contents and format of a hypermedia document (e.g., a web page).

Through the use of the web, individuals have access to millions of pages of information. However a significant drawback with using the web is that because there is so little organization, at times it can be extremely difficult for users to locate the particular pages that contain the information that is of interest to them. To address this problem, “search engines” have been developed to index a large number of web pages and to provide an interface that can be used to search the indexed information by entering certain words or phases to be queried.

Search engines may generally be constructed using several common functions. Typically, each search engine has one or more at least one “web crawlers” (also referred to as “crawler”, “spider”, “robot”) that “crawls” across the Internet in a methodical and automated manner to locate web documents around the world. Upon locating a document, the crawler stores the document's uniform resource locator (URL), and follows any hyperlinks associated with the document to locate other web documents. Also, each search engine may include information extraction and indexing mechanisms that extract and index certain information about the documents that were located by the crawler. In general, index information is generated based on the contents of the HTML file associated with the document. The indexing mechanism stores the index information in large databases that can typically hold an enormous amount of information. Further, each search engine provides a search tool that allows users, through a user interface, to search the databases in order to locate specific documents, and their location on the web (e.g., a URL), that contain information that is of interest to them.

Information Extraction (IE) systems may be used to gather and manipulate the unstructured and semi-structured information on the web and populate backend databases with structured records. Such systems may face difficulties due to the complexity and variability of the large numbers of web pages from which information is to be gathered. Such systems may require a great deal of cost, both in terms of computing resources and time. Further, while a large percentage of data on the Web is served from logically well organized data sources with URLs that encode information necessary to publish the data on the Web, difficulties may be faced in taking advantage of the information contained in URLs due to problems of URL alignment.

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 depicts an example URL segmented into a plurality of tokens and associated labels in accordance with an embodiment;

FIG. 2 depicts several example URLs in accordance with an example embodiment;

FIG. 3 is a diagram depicting several sequence sets associated with several example URLs in accordance with an embodiment;

FIG. 4 is a diagram depicting several aligned sequence sets associated with several example URLs in accordance with an embodiment;

FIG. 5 is a flow diagram of an example embodiment of a process for aligning a number of URLs;

FIG. 6 is a block diagram depicting an information extraction system comprising a clustering process, a sequence model, and a URL normalization process in accordance with an example embodiment;

FIG. 7 is a flow diagram of an example embodiment of a process for aligning and normalizing a number of URLs;

FIG. 8 is a block diagram of an example computing system in accordance with an embodiment; and

FIG. 9 is a block diagram of an example information integration system in accordance with an embodiment.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Embodiments claimed may include one or more apparatuses for performing the operations herein. These apparatuses may be specially constructed for the desired purposes, or they may comprise a general purpose computing platform selectively activated and/or reconfigured by a program stored in the device. The processes and/or displays presented herein are not inherently related to any particular computing platform and/or other apparatus. Various general purpose computing platforms may be used with programs in accordance with the teachings herein, or it may prove convenient to construct a more specialized computing platform to perform the desired method. The desired structure for a variety of these computing platforms will appear from the description below.

Embodiments claimed may include algorithms, programs, processes, and/or symbolic representations of operations on data bits or binary digital signals within a computer memory capable of performing one or more of the operations described herein. Although the scope of claimed subject matter is not limited in this respect, one embodiment may be in hardware, such as implemented to operate on a device or combination of devices, whereas another embodiment may be in software. Likewise, an embodiment may be implemented in firmware, or as any combination of hardware, software, and/or firmware, for example. These algorithmic descriptions and/or representations may include techniques used in the data processing arts to transfer the arrangement of a computing platform, such as a computer, a computing system, an electronic computing device, and/or other information handling system, to operate according to such programs, algorithms, and/or symbolic representations of operations. A program and/or process generally may be considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities. In addition, embodiments are not described with reference to any particular programming language. It will be appreciated that a variety of programming languages may be used to implement the teachings described herein.

Likewise, although the scope of claimed subject matter is not limited in this respect, one embodiment may comprise one or more articles, such as a storage medium or storage media. This storage media may have stored thereon instructions that when executed by a computing platform, such as a computer, a computing system, an electronic computing device, and/or other information handling system, for example, may result in an embodiment of a method in accordance with claimed subject matter being executed, for example. The terms “storage medium” and/or “storage media” as referred to herein relate to media capable of maintaining expressions which are perceivable by one or more machines. For example, a storage medium may comprise one or more storage devices for storing machine-readable instructions and/or information. Such storage devices may comprise any one of several media types including, but not limited to, any type of magnetic storage media, optical storage media, semiconductor storage media, disks, floppy disks, optical disks, CD-ROMs, magnetic-optical disks, read-only memories (ROMs), random access memories (RAMs), electrically programmable read-only memories (EPROMs), electrically erasable and/or programmable read-only memories (EEPROMs), flash memory, magnetic and/or optical cards, and/or any other type of media suitable for storing electronic instructions, and/or capable of being coupled to a system bus for a computing platform. However, these are merely examples of a storage medium, and the scope of claimed subject matter is not limited in this respect.

The term “instructions” as referred to herein relates to expressions which represent one or more logical operations. For example, instructions may be machine-readable by being interpretable by a machine for executing one or more operations on one or more data objects. However, this is merely an example of instructions, and the scope of claimed subject matter is not limited in this respect. In another example, instructions as referred to herein may relate to encoded commands which are executable by a processor having a command set that includes the encoded commands. Such an instruction may be encoded in the form of a machine language understood by the processor. For an embodiment, instructions may comprise run-time objects, such as, for example, Java and/or Javascript objects. However, these are merely examples of an instruction, and the scope of claimed subject matter is not limited in this respect.

Unless specifically stated otherwise, as apparent from the following discussion, it is appreciated that throughout this specification discussions utilizing terms such as processing, computing, calculating, selecting, forming, enabling, inhibiting, identifying, initiating, receiving, transmitting, determining, estimating, incorporating, adjusting, modeling, displaying, sorting, applying, varying, delivering, appending, making, presenting, distorting and/or the like refer to the actions and/or processes that may be performed by a computing platform, such as a computer, a computing system, an electronic computing device, and/or other information handling system, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, processes described herein, with reference to flow diagrams or otherwise, may also be executed and/or controlled, in whole or in part, by such a computing platform.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

As used herein, the term “uniform resource identifier” is meant to include any electronic object that identifies a resource on a network and that includes information for locating the resource. URIs may be said to act as references to web pages on the Internet, for example. One example of a URI is a URL. Therefore, although the example embodiments described herein discuss URLs, the scope of claimed subject matter is not so limited, and one or more of the example embodiments described herein may be utilized in connection with any URI.

As discussed above, information extraction systems may face difficulties due to the complexity and variability of the enormous numbers of web pages from which information may be gathered. Such systems may require a great deal of cost, both in terms of resources and time. Further, while a large percentage of data on the Web is served from logically well organized data sources with URLs that encode information necessary to publish the data on the Web, difficulties may be faced in taking advantage of the information contained in URLs due to problems of URL alignment, as discussed below.

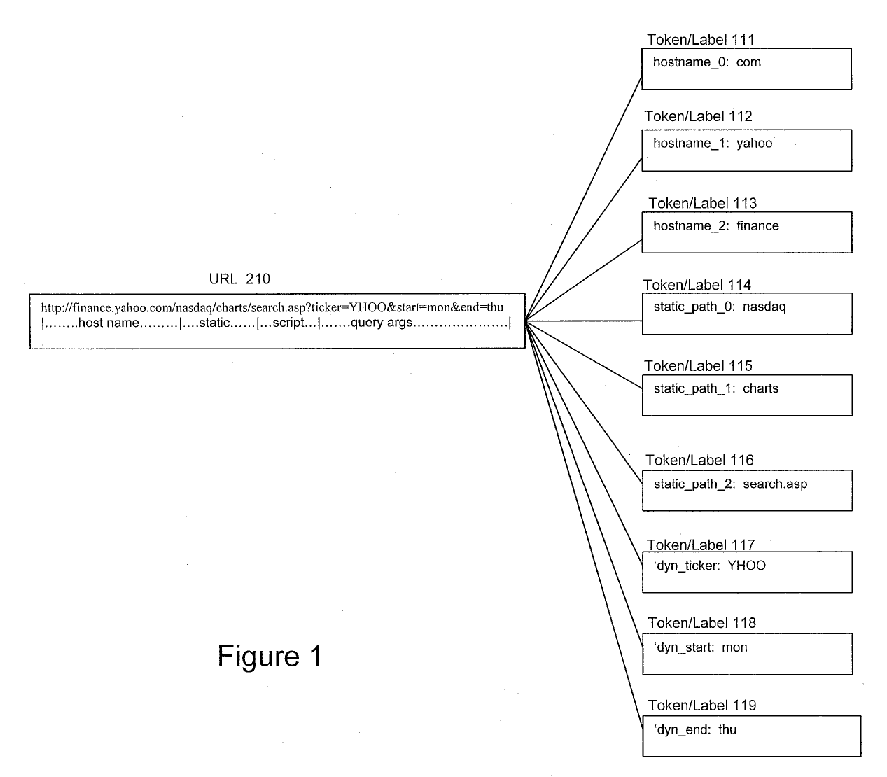

FIG. 1 depicts an example URL 210 segmented into a number of tokens and associated labels 111-119. For this example, URL 210 comprises, as shown in FIG. 1, “http://finance.yahoo.com/nasdaq/charts/search.asp?ticker=YHOO&start=mon&end=thu”. For many operations involving the analysis of URLs, it may be desirable to “tokenize” a URL. That is, the URL may be parsed into various tokens that may represent various types of information, as discussed more fully below. The information provided by the tokens may directly provide information about the web page associated with the URL, and/or may provide pointers to information that may be stored in one more databases. Tokens from a URL may explicitly mention keywords regarding the web page to which the URL refers, and/or may include information made implicit through encoding a keyword in some manner. For example, a URL may include the token “electronics” as an explicit keyword, while another URL may include a code such as “11034” that may represent the keyword “electronics.”

For one or more embodiments, a sequence modeling process may be utilized to tokenize the URL and to identify labels that may be associated with the tokens. For one or more embodiments, the sequence modeling process may comprise a machine learning process that may be utilized to segment the URL into the plurality of tokens. The tokens may be associated with one or more labels that may correspond to one or more predefined classes. Also, for one or more embodiments, the URL may be tokenized by the machine learning process based, at least in part, on a predefined set of delimiters. Such delimiters may include, but are not limited to, ‘/’, ‘&’, ‘?’, ‘_’, ‘−’, ‘=’, etc. The delimiters themselves may be referred to as tokens. The delimiter tokens may aid in identifying class boundaries. For an embodiment, tokens may be associated with one or more features. These features may comprise observed characteristics of one or more URLs. Different types of features may be defined that may aid in the segmentation process. URLs may lend themselves to sequence modeling processes such as those discussed herein at least in part due to the sequential nature of the URLs. For example, a URL of http://abcd.com/Electronics/Ipod may convey a sequence comprising a first static component of a first level category of “Electronics” and a second static component “Ipod” which, for this example, comprises a sub-category of “Electronics.”

For the present example of URL 210, the URL may comprise several main components. As shown in FIG. 1, the URL may comprise a host name component, a static component, a script component, and query arguments. Of course, this is merely an example of possible components of a URL, and the scope of claimed subject matter is not limited in this regard. For this example, the hostname component may be segmented into several tokens. Token 111 for this example is named hostname_0, and is associated with the label “com”. Token 112 is named hostname_1, and is associated with the label “yahoo”. Token 113 is named hostname_2, and is associated with the label “finance”. Tokens 111-113 for this example together represent the hostname component of URL 210.

Also for this example, the static component of URL may be segmented into tokens 114-116, as depicted in FIG. 1. For this example, token 114 is named static_path_0, and is associated with the label “nasdaq”. Token 115 is named static_path_1, and is associated with the label “charts”. Also, token 116 is named static_path_2, and is associated with the label “search.asp”. Tokens 114-116 for this example together represent the static component of URL 210. Note that for this example, the script component is considered to be part of the static component.

Further, for this example, the query arguments component of URL may be segmented into several tokens. For this example, the query arguments component of URL 210 may be represented by tokens 117-119, as depicted in FIG. 1. Token 117 is named “dyn_ticker”, and is associated with the label “YHOO”. Token 118 is named “dyn_start”, and is associated with the label “mon”. Also, token 119 is named “dyn_end”, and is associated with the label “thu”.

URLs and their characteristics may be analyzed for a wide range of purposes. For example, an information extraction system may desire to analyze a number of URLs to determine whether any of the URLs are duplicates of each other or of previous URLs associated with web pages that have been previously crawled. Information extraction systems may operate in a much more efficient manner if duplicate URLs can be detected, thereby avoiding redundant extraction of information from a given web page. In determining whether several URLs are duplicates, the information extraction system may analyze the several URLs according to their characteristics to determine whether the URLs point to the same web page. Search engine implementations may also benefit from identification of duplicate URLs, in that duplicate search results may be identified and not presented to the user. This analysis, for one example, may be made more burdensome in the case of mis-aligned URLS.

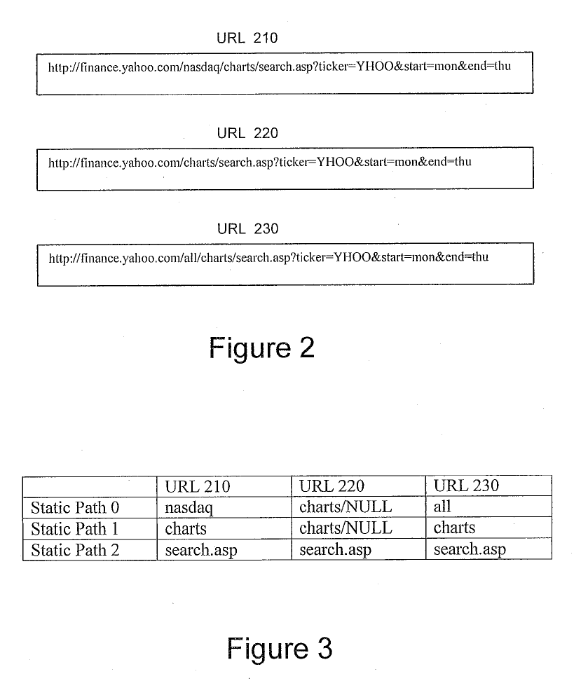

As an example of mis-aligned URLs, consider URL 210, URL 220, and URL 230 as depicted in FIG. 2. URL 210 is described above in connection with FIG. 1. For this example, URL 220 comprises “http://finance.yahoo.com/charts/search.asp?ticker=YHOO&start=mon&end=thu”, and URL 230 comprises “http://finance.yahoo.com/all/charts/search.asp?ticker=YHOO&start=mon&end=thu”, as depicted in FIG. 2.

FIG. 3 depicts a chart illustrating an attempt to align the static portions of URLs 210-230. By observing FIG. 3, one can discern a possible difficulty in analyzing the URLs due to the misalignment of the static path 0 tokens. For example, the static path 0 token for URL 210 is “nasdaq”, and the static path 0 token for URL 230 is “all”. Further, the static path 0 token of URL 220 cannot be defined, because the value may be either “charts” or NULL. This is due, at least in part, to URL 220 including one fewer static component than the other two URLs. Therefore, in analyzing the URLs it is not apparent whether the “charts” label properly belongs to static path 0 or to static path 1.

For an embodiment, an example process for aligning URLs may make use of techniques commonly found in the field of bioinformatics. One such technique may comprise sequence alignment. In bioinformatics, a sequence alignment is a way of arranging the primary sequences of protein, DNA, or RNA to identify regions of similarity that may be a consequence of functional, structural, or evolutionary relationships between the sequences. In the field of sequence alignment, “pairwise” sequence alignment techniques may be used to find the best matching alignments of two query sequences. Multiple sequence alignment (MSA) may be viewed and an extension of the pairwise alignment techniques to incorporate more than two sequences at a time. Multiple alignment techniques may try to align all of the sequences of a given query set. Multiple sequence alignment may generally comprise a sequence alignment of three or more biological sequences, generally protein, DNA, or RNA. In general, the input set of sequences are assumed to have an evolutionary relationship by which they share a lineage and are descended from a common ancestor.

For one or more embodiments, the sequence alignment processes described briefly above and as commonly used in the field of bioinformatics may be utilized to align a number of URLs, thereby helping to avoid the difficulties inherent with misalignment of URLs, an example of which is described above. For an embodiment, multiple sequence alignment may be utilized to align a number of URLs.

In an embodiment, a number of URLs may be segmented into sequences of tokens. These sequences may be processed according to the multiple sequence alignment methods described above to produce a number of aligned sequence sets. Once aligned, the URLs (or the aligned sequence sets that correspond to the URLs) may be used in a wide range of applications that may benefit from the aligned URLs. Such applications may include, but are not limited to, information extraction, information retrieval, computational advertisement, search engines, URL and/or URI normalization, sitemap construction, etc. Therefore, the information extraction example embodiments described herein are merely example applications of aligned URIs, and the scope of claimed subject matter is not limited in these respects. Of course, embodiments described herein may be advantageously utilized in any number of other related aspects of applications involving the Web and/or the Internet.

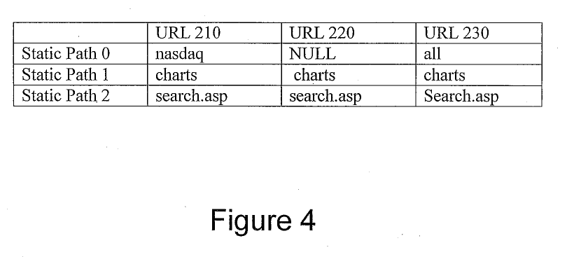

FIG. 4 represents a possible output of a multiple sequence alignment process as applied to the example URLs described above in connection with FIGS. 2 and 3. As can be seen by observing the table of FIG. 4, the multiple sequence alignment process has reconciled the ambiguity previously found in URL 220 regarding the correct alignment for the token “charts”. For this example, the correct alignment for the token “charts” for URL 220 is at static path 1, as shown in FIG. 4. The aligned sequences may be analyzed for any of a range of purposes and/or applications, examples of which are described below. For one example, an information extraction process may analyze the aligned sequences to determine whether any or all of the URLs refer to the same web page. If duplicate URLs are found, the information extraction process may ignore the duplicate URLs, thereby improving crawling efficiency. Of course, this is merely an example of how aligned sequences representing URLs may be utilized, and the scope of claimed subject matter is not limited in this respect.

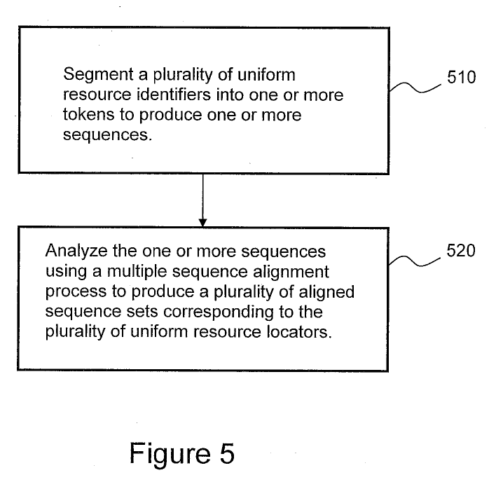

FIG. 5 is a flow diagram of an example embodiment of a process for aligning a plurality of uniform resource locators. At block 510, a plurality of uniform resource locators may be segmented into one or more tokens to produce one or more sequences. For an embodiment, the segmentation may be accomplished via a machine learning process. An example of such a machine learning process comprises a conditional random fields process, although the scope of claimed subject matter is not limited in this respect. At block 520, the one or more sequences may be analyzed using a multiple sequence alignment process to produce a plurality of aligned sequence sets corresponding to the plurality of uniform resource locators. For an embodiment, the multiple sequence alignment process may comprise a progressive method (also referred to as a hierarchical or tree method) for performing the alignment. The progressive method may generate a multiple sequence alignment by first aligning the most similar sequences and adding successively less related sequences to the alignment until all of the sequences have been incorporated into the solution.

For other embodiments, other techniques for multiple sequence alignment may be utilized including, but not limited to, dynamic programming and/or iterative methods. Other techniques for multiple sequence alignment may also include techniques from computer science, such as, for example, hidden Markov models. However, these are merely examples of techniques for performing sequence alignment for one or more embodiments, and the scope of claimed subject matter is not limited in these respects. Also, embodiments in accordance with claimed subject matter may include all, more than all, or less than all of blocks 510-520. Further, the order of blocks 510-520 is merely an example order, and claimed subject matter is not limited in these respects.

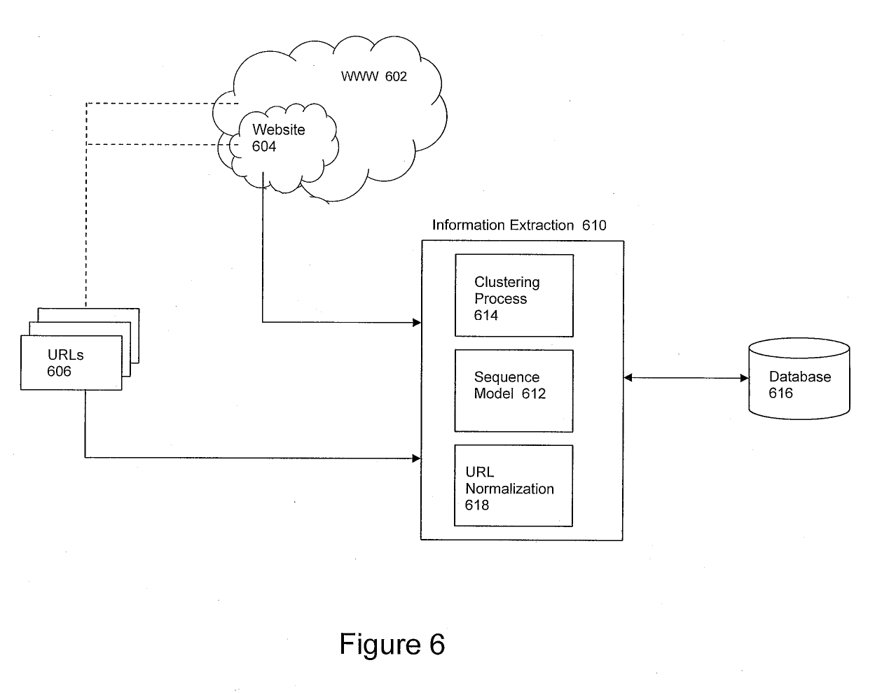

FIG. 6 is a block diagram depicting an example system including an example embodiment of an information extraction platform 610. Information extraction platform 610 may comprise a sequence model 612, a clustering process 614, and a URL normalization unit 618. For this example, sequence model 612 may comprise a machine learning process, although the scope of claimed subject matter is not limited in this respect. Information extraction platform 610 may operate to crawl the world wide web 602 in order to gather information that may be used for a wide range of purposes, including, but not limited to, providing information for search engine databases, or for targeting advertising to appropriate audiences, etc.

Sequence model 612 may be trained using information gathered from a subset of websites from www 602. To train the machine learning process, the contents of the web pages from subset 602 may be analyzed to gleam information that may be stored by sequence model 612. Sequence model 612 may segment one or more URLs 606 corresponding to pages from website 604 to produce tokens that may be associated with one or more labels that may represent various types of information, such as, for example and not by way of limitation, domain names, web site classifications, product categories, product types, product identifiers, etc. Information extraction platform 610 may store the information gleamed from the web pages in a database 616 in one or more embodiments.

Information extraction platform 610 for this example also comprises URL normalization unit 618. URL normalization may comprise a process by which URLs may be modified and/or standardized in a consistent manner. One possible benefit of URL normalization is that if the URLs are in a standardized format, it becomes easier to analyze the URLs, for example to determine if two syntactically different URLs are equivalents of each other (that is, the URLs refer to the same web page). For this example, URL normalization unit 618 may receive the aligned sequence sets produces by the multiple sequence alignment process 612.

Also for this example, information extraction platform 610 may comprise clustering process 614. As is well known, URLs may act as queries to databases to publish information on the web. However, because there are typically multiple data sources for each web site, the patterns of the URLs may be different across data sources. Therefore, performing global alignment of URLs at a domain level may have some disadvantages due to the alignment being performed on URLs of different types. The efficiency and effectiveness of multiple sequence alignment techniques may depend, at least in part, on how closely related the various URLs to be analyzed are. Clustering may comprise processes to group together URLs that may be related in ways that would be advantageous to the sequence alignment process.

One example technique for grouping URLs into one or more clusters may comprise script based grouping. Web sites may utilize scripts to generate web pages. Many web sites on the Internet have multiple scripts for different types of entities. For example, a first script may be used to generate all of the shopping pages on the web site, and a second script may be used to generate all of the travel pages. Therefore, grouping URLs according to one or more scripts observed in the URLs may result in the URLs being grouped into clusters of related URLs. For this simple example, all of the URLs related to shopping pages would be grouped into a first cluster, and the URLs related to travel pages would be grouped into a second cluster.

Another example technique for grouping URLs into one or more clusters may comprise duplicate cluster based grouping. This technique may be advantageous in situation where the script based clustering is ineffective (or not as effective as it might otherwise be). This may occur in situations where the web site is not very well organized, such as where a single script is used to generate all of the pages of web site with divers types of pages. Duplicate cluster based grouping may comprise algorithms that cluster near duplicate pages together. The term “near duplicate” as used herein is meant to denote syntactically similar URLs. Any number of techniques for grouping together essentially syntactically similar URLs may be used.

The clustering techniques described herein are merely example clustering techniques, and the scope of claimed subject matter is not limited in these respects. Also, the embodiment described in connection with FIG. 6 is merely an example embodiment, and the scope of claimed subject matter is not limited in this respect.

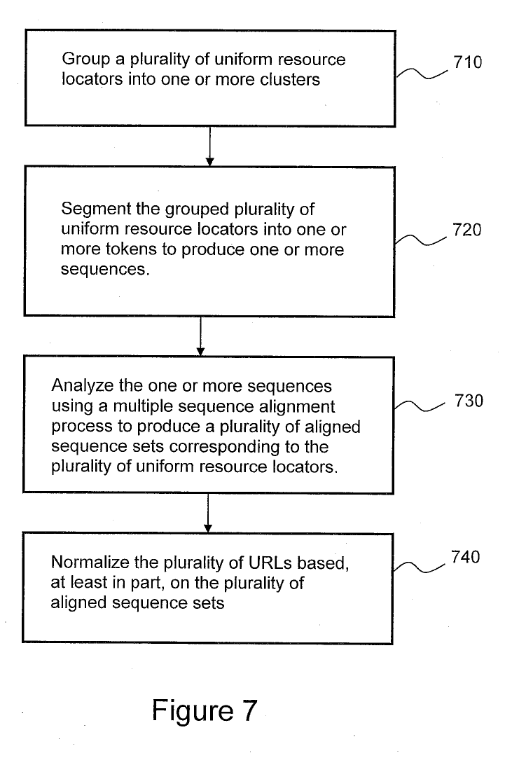

FIG. 7 is a flow diagram of an example embodiment of a process for producing a plurality of aligned sequence sets that may be utilized in normalization processing. At block 710, a plurality of uniform resource locators may be grouped into one or more cluster. At block 720, the grouped plurality of URLs may be segmented into one or more tokens to produce one or more sequences. For an embodiment, the segmentation may be performed according to a machine learning process. Also for one or more embodiments, the machine learning process may comprise a Conditional Random Fields (CRF) process, although the scope of claimed subject matter is not limited in this respect. In general, CRFs comprise a probabilistic framework for labeling and segmenting sequential data, based on a conditional model. The conditional model may be used to label a novel observation sequence “x” by selecting a label sequence “y” that maximizes the conditional probability of p(x|y). In one or more embodiments, the CRFs may comprise linear chain CRFs, although, again, the scope of claimed subject matter is not limited in this respect. Linear chain CRFs may capture the sequential dependency between adjacent tokens for a URL.

At block 730, the one or more sequences may be analyzed using a multiple sequence alignment process to produce a plurality of aligned sequence sets corresponding to the plurality of URLs, and at 740 the plurality of URLs may be normalized based, at least in part, on the plurality of aligned sequence sets. For one or more embodiments, the techniques for producing aligned sequence sets and for normalizing the URLs may comprise those example techniques described above. Embodiments in accordance with claimed subject matter may include all, more than all, or less than all of blocks 710-740. Further, the order of blocks 710-740 is merely an example order, and claimed subject matter is not limited in these respects.

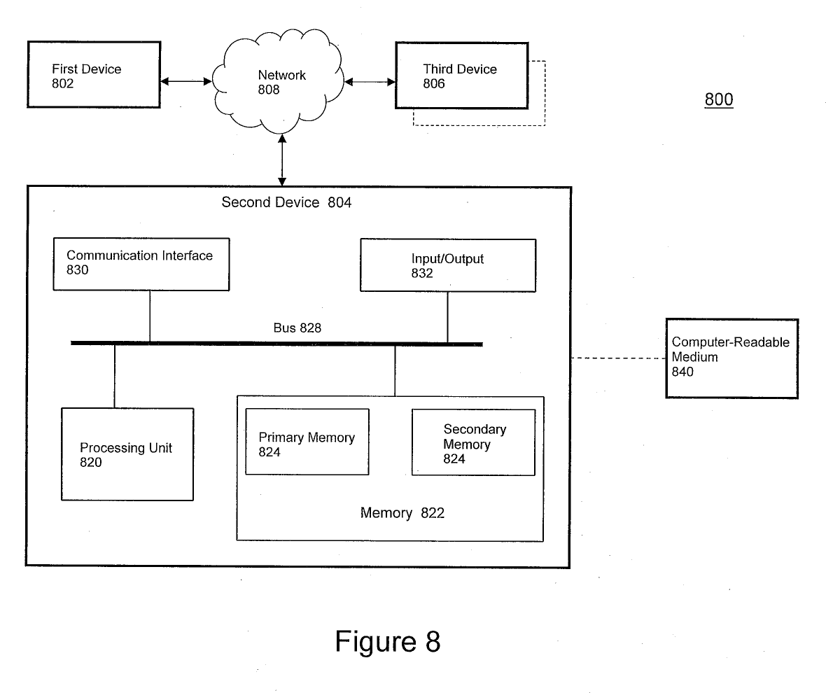

FIG. 8 is a block diagram of an exemplary embodiment of a computing environment system 800 that may include one or more devices configurable to and/or that may be directed to perform URL alignment operations in accordance with embodiments discussed above in connection with FIGS. 1-7. System 800 may include, for example, a first device 802, a second device 804, and a third device 806, which may be operatively coupled together through a network 808.

First device 802, second device 804 and third device 806, as shown in FIG. 8, may be representative of any device, appliance or machine that may be configurable to exchange data over network 808. By way of example but not limitation, any of first device 802, second device 804, or third device 806 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 808, as shown in FIG. 8, is representative of one or more communication links, processes, and/or resources configurable to support the exchange of data between at least two of first device 802, second device 804, and third device 806. By way of example but not limitation, network 808 may include wireless and/or wired communication links, telephone or telecommunications systems, data buses or channels, optical fibers, terrestrial or satellite resources, local area networks, wide area networks, intranets, the Internet, routers or switches, and the like, or any combination thereof. As illustrated, for example, by the dashed lined box illustrated as being partially obscured of third device 806, there may be additional like devices operatively coupled to network 808.

It is recognized that all or part of the various devices and networks shown in system 800, and the processes and methods as further described herein, may be implemented using or otherwise include hardware, firmware, software, or any combination thereof.

Thus, by way of example but not limitation, second device 804 may include at least one processing unit 820 that is operatively coupled to a memory 822 through a bus 828.

Processing unit 820 is representative of one or more circuits configurable to perform at least a portion of a data computing procedure or process. By way of example but not limitation, processing unit 820 may include one or more processors, controllers, microprocessors, microcontrollers, application specific integrated circuits, digital signal processors, programmable logic devices, field programmable gate arrays, and the like, or any combination thereof.

Memory 822 is representative of any data storage mechanism. Memory 822 may include, for example, a primary memory 824 and/or a secondary memory 826. Primary memory 824 may include, for example, a random access memory, read only memory, etc. While illustrated in this example as being separate from processing unit 820, it should be understood that all or part of primary memory 824 may be provided within or otherwise co-located/coupled with processing unit 820.

Secondary memory 826 may include, for example, the same or similar type of memory as primary memory and/or one or more data storage devices or systems, such as, for example, a disk drive, an optical disc drive, a tape drive, a solid state memory drive, etc. In certain implementations, secondary memory 826 may be operatively receptive of, or otherwise configurable to couple to, a computer-readable medium 840. Computer-readable medium 840 may include, for example, any medium that can carry and/or make accessible data, code and/or instructions for one or more of the devices in system 800.

Second device 804 may include, for example, a communication interface 830 that provides for or otherwise supports the operative coupling of second device 804 to at least network 808. By way of example but not limitation, communication interface 830 may include a network interface device or card, a modem, a router, a switch, a transceiver, and the like.

Second device 804 may include, for example, an input/output 832. Input/output 832 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 832 may include an operatively configured display, speaker, keyboard, mouse, trackball, touch screen, data port, etc.

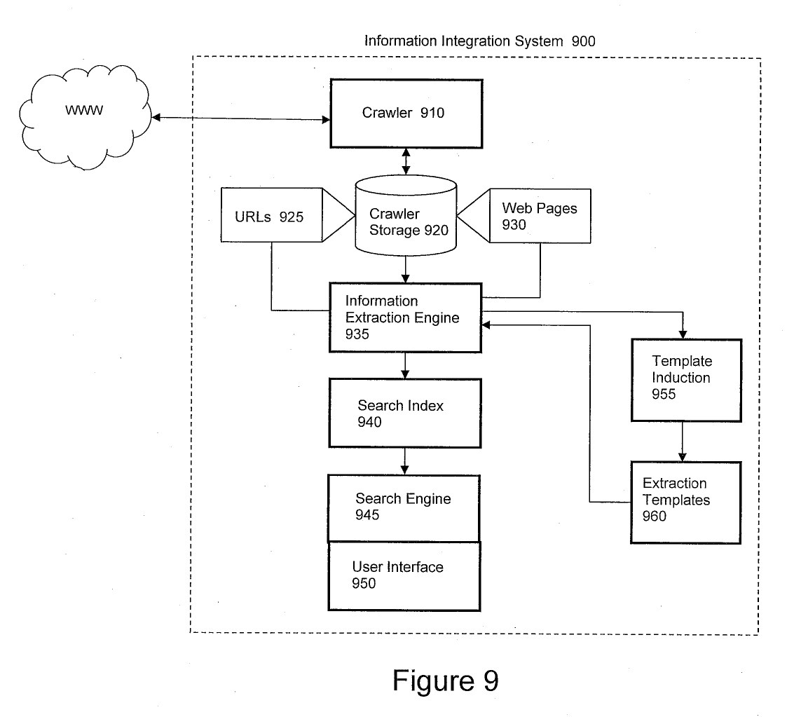

FIG. 9 is a block diagram of an example information integration system (IIS) 900 in accordance with an embodiment. The context in which an IIS may be implemented may vary. By way of non-limiting examples, an IIS such as IIS 900 may be implemented for public or private search engines, job portals, shopping search sites, travel search sites, RSS (Really Simple Syndication) based applications and sites, and the like. Embodiments are described herein primarily in the context of a World Wide Web (WWW) search system, for purposes of an example. However, the scope of claimed subject matter is not limited to these examples. Embodiments are possible where the implementation is not limited to Web search systems. For example, embodiments may be implemented in the context of private enterprise networks (e.g., intranets), as well as the public network of networks (i.e., the Internet), although, again, the scope of claimed subject matter is not limited in these respects.

IIS 900 may comprise a crawler 910 communicatively coupled to a source of information, such as the Internet and the World Wide Web (WWW). IIS 900 may further comprise a crawler storage 920, a search engine 945 backed by a search index 940 and associated with a user interface 950.

A web crawler (also referred to as “crawler”, “spider”, “robot”), such as crawler 910, may operate to “crawl” across the Internet in a methodical and automated manner to locate web pages around the world. Upon locating a page, the crawler may store the page's URL in URLs 925, and may follow any hyperlinks associated with the page to locate other web pages. The crawler may also stores entire web pages 930 (e.g., HTML and/or XML code) and URLs 925 in crawler storage 920. Use of this information, according to embodiments of the invention, are described in greater detail herein.

Search engine 795 generally refers to a mechanism that may be used to index and search a large number of web pages, and may be used in conjunction with user interface 950 that may be used by a user to search the search index 940 by entering certain words or phases to be queried. In general, the index information stored in search index 940 may be generated based on extracted contents of the HTML file associated with a respective page, for example, as extracted using extraction templates 960 generated by template induction techniques 955. For one or more embodiments, techniques such as those described above for gathering information about web pages through the analysis of URLs may be utilized to extract index information regarding the web pages. Generation of the index information may comprise a main purpose of system 900, and such information may be generated with the assistance of an information extraction engine 935. For example, if crawler 910 is storing all the pages that have job descriptions, extraction engine 935 may extract useful information from these pages, such as the job title, location of job, experience required, etc. and use this information to index the page in the search index 940. Again, such information may in one or more embodiment be extracted through analysis of URLs, as described previously. One or more search indexes 940 associated with search engine 945 may comprise a list of information accompanied with the location of the information, i.e., the network address of, and/or a link to, the page that contains the information.

As mentioned, extraction templates 960 may be used to facilitate the extraction of desired information from a group of web pages, such as by information extraction engine 935. Further, extraction templates 955 may be based on the general layout of the group of pages for which a corresponding extraction template is defined. For example, as previously described, an extraction template may be implemented as an HTML file that describes different portions of a group of pages. Template induction processes 955 may be used to generate extraction templates 960.

Information integration system 900 may be implemented in hardware or software, or in a combination of hardware and software. For example, IIS 900 may be implemented in accordance with second device 804, described above.

It should also be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Such software and/or firmware may be expressed as machine-readable instructions which are executable by a processor. Likewise, although the claimed subject matter is not limited in scope in this respect, one embodiment may comprise one or more articles, such as a storage medium or storage media. This storage media, such as one or more CD-ROMs and/or disks, for example, may have stored thereon instructions, that when executed by a system, such as a computer system, computing platform, or other system, for example, may result in an embodiment of a method in accordance with the claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

What is claimed is:

1. A method, comprising:
segmenting a plurality of uniform resource identifiers into one or more tokens to produce one or more sequences; and
analyzing the one or more sequences using a multiple sequence alignment process to produce a plurality of aligned sequence sets corresponding to the plurality of uniform resource identifiers.

2. The method of claim 1, wherein said multiple sequence alignment process comprises a dynamic programming technique to identify the plurality of aligned sequence sets.

3. The method of claim 1, wherein said multiple sequence alignment process comprises a progressive alignment technique.

4. The method of claim 3, wherein said progressing alignment technique comprises aligning a plurality of most similar sequences and performing a series of subsequent alignments on successively less closely related sequences.

5. The method of claim 1, wherein said multiple sequence alignment process comprises an iterative method.

6. The method of claim 1, further comprising grouping the plurality of uniform resource identifiers into one or more clusters prior to said analyzing the one or more tokens of the plurality of uniform resource locators.

7. The method of claim 6, wherein said grouping the plurality of uniform resource identifiers into one or more clusters comprises grouping the plurality of uniform resource identifiers based, at least in part, on one or more scripts associated with a web site, wherein said one or more scripts are utilized to generate one or more pages in the web site.

8. The method of claim 6, wherein said grouping the plurality of uniform resource identifiers into one or more clusters comprises grouping together one or more subsets of uniform resource identifiers, wherein each of the subsets comprises one or more uniform resource identifiers that represent pages from a web site that are essentially syntactically similar to each other.

9. The method of claim 1, further comprising normalizing the plurality of uniform resource identifiers based, at least in part, on the plurality of aligned sequence sets.

10. The method of claim 1, further comprising creating a site map of at least a portion of a web site based, at least in part, on the plurality of aligned sequence sets.

11. The method of claim 1, further comprising utilizing the plurality of aligned sequence sets in one or more of the following applications: information retrieval, advertisement, search engines, search relevance, and/or information extraction.

12. An article, comprising: a storage medium having stored thereon instructions that, if executed, direct a computing platform to:
segment a plurality of uniform resource identifiers into one or more tokens to produce one or more sequences; and
analyze the one or more sequences using a multiple sequence alignment process to produce a plurality of aligned sequence sets corresponding to the plurality of uniform resource identifiers.

13. The article of claim 12, wherein said storage medium has stored thereon further instructions that, if executed, direct the computing platform to perform the multiple sequence alignment process using a dynamic programming technique to identify the plurality of aligned sequence sets.

14. The article of claim 12, wherein said storage medium has stored thereon further instructions that, if executed, direct the computing platform to perform the multiple sequence alignment process using a progressive alignment technique.

15. The article of claim 14, wherein said storage medium has stored thereon further instructions that, if executed, direct the computing platform to perform said progressive alignment technique by aligning a plurality of most similar sequences and performing a series of subsequent alignments on successively less closely related sequences.

16. The article of claim 12, wherein said storage medium has stored thereon further instructions that, if executed, direct the computing platform to perform said multiple sequence alignment process using an iterative method.

17. The article of claim 12, wherein the storage medium has stored thereon further instructions that, if executed, direct the computing platform to group the plurality of uniform resource identifiers into one or more clusters prior to said analyzing the one or more tokens of the plurality of uniform resource identifiers.

18. The article of claim 17, wherein the storage medium has stored thereon further instructions that, if executed, direct the computing platform to group the plurality of uniform resource identifiers based, at least in part, on one or more scripts associated with a web site, wherein said one or more scripts are utilized to generate one or more pages in the web site.

19. The article of claim 17, wherein the storage medium has stored thereon further instructions that, if executed, direct the computing platform to group together one or more subsets of uniform resource identifiers, wherein each of the subsets comprises on or more uniform resource identifiers that represent pages from a web site that are essentially syntactically similar to each other.

20. The article of claim 12, wherein the storage medium has stored thereon further instructions that, if executed, direct the computing platform to normalize the plurality of uniform resource identifiers based, at least in part, on the plurality of aligned sequence sets.

21. The article of claim 12, wherein the storage medium has stored thereon further instructions that, if executed, direct the computing platform to create a site map of a web site based, at least in part, on the plurality of aligned sequence sets.

22. The article of claim 12, wherein the storage medium has stored thereon further instructions that, if executed, direct the computing platform to utilize the plurality of aligned sequence sets in one or more of the following applications: information retrieval, advertisement, search engines, search relevance, and/or information extraction.

23. An apparatus, comprising:
means for segmenting a plurality of uniform resource identifiers into one or more tokens to produce one or more sequences; and
means for analyzing the one or more sequences using a multiple sequence alignment process to produce a plurality of aligned sequence sets corresponding to the plurality of uniform resource identifiers.

24. The apparatus of claim 23, wherein said multiple sequence alignment process comprises a dynamic programming technique to identify the plurality of aligned sequence sets.

25. The apparatus of claim 23, wherein said multiple sequence alignment process comprises a progressive alignment technique.

26. The apparatus of claim 25, wherein said progressive alignment technique comprises aligning a plurality of most similar sequences and performing a series of subsequent alignments on successively less closely related sequences.

27. The apparatus of claim 23, wherein said multiple sequence alignment process comprises an iterative method.

28. The apparatus of claim 23, further comprising means for grouping the plurality of uniform resource identifiers into one or more clusters prior to said analyzing the one or more tokens of the plurality of uniform resource identifiers.

29. The apparatus of claim 28, wherein said means for grouping the plurality of uniform resource identifiers into one or more clusters comprises means for grouping the plurality of uniform resource identifiers based, at least in part, on one or more scripts associated with a web site, wherein said one or more scripts are utilized to generate one or more pages in the web site.

30. The apparatus of claim 28, wherein said means for grouping the plurality of uniform resource identifiers into one or more clusters comprises means for grouping together one or more subsets of uniform resource identifiers, wherein each of the subsets comprises on or more uniform resource identifiers that represent pages from a web site that are essentially syntactically similar to each other.

31. The apparatus of claim 23, further comprising means for normalizing the plurality of uniform resource identifiers based, at least in part, on the plurality of aligned sequence sets.

32. The apparatus of claim 23, further comprising means for creating a site map of a web site based, at least in part, on the plurality of aligned sequence sets.

33. The apparatus of claim 23, further comprising means for utilizing the plurality of aligned sequence sets in one or more of the following applications: information retrieval, advertisement, search engines, search relevance, and/or information extraction.
